(19) United States
(12) Patent Application Publication
(10) Pub. No.: US 2004/0081177 A1
(43) Pub. Date: Apr. 29, 2004

(54) Telecommunication router

(75) Inventors: Wim Henderickx, Westerlo (BE); Peter Alfons Van Hessche, Merelbeke (BE); Guido Josef Nelly Hereygers, Essen (BE)

Correspondence Address: SUGHRUE MION, PLLC,, 2100 Pennsylvania Avenue, N.W., Washington, DC, 20037-3213, US

(73) Assignee: ALCATEL

(21) Appl. No.: 10/690,544

(22) Filed: Oct. 23, 2003

(30) Foreign Application Priority Data
Oct. 24, 2002 (EP) 02292637.2

(51) Int. Cl. H04L 12/28; H04L 12/56

(52) U.S. Cl. 370/401

(57) ABSTRACT

A telecommunication router (TLK, RTS) connected to a termination link (TL) and comprising a packet classifier (CL) receiving packets of data from the link and classifying them according to their type and an associated priority, a plurality of queues (P0-P3) storing the packets received from the classifier, and a processor (PROC) handling the packets stored in the queues. Each queue is associated to a predetermined priority and the classifier forwards each packet to the queue corresponding to its priority. The processor retrieves the packets from the queues according to predetermined priority rules. The packets are treated based on the current load of the processor and, owing to the buffering in the queues, the processing power is used as much as possible and a maximum of packets is processed as a function of the available processing power.

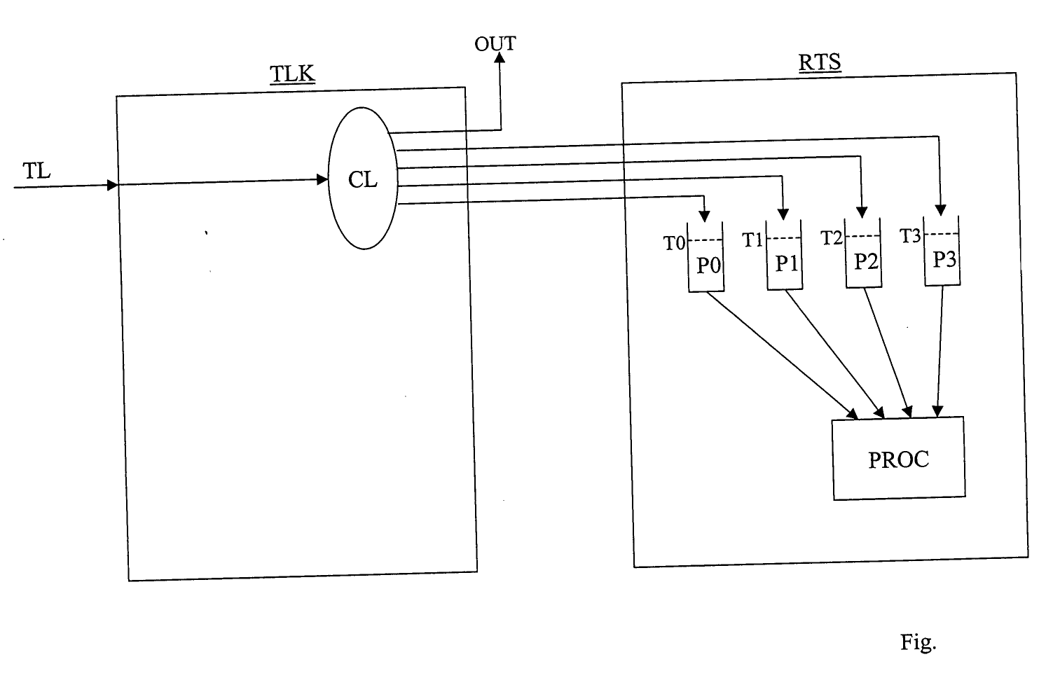

The present invention relates to a telecommunication router connected to a termination link and comprising a processor adapted to handle packets of data received from said link.

Such a telecommunication router is already known in the art and is generally an IP [Internet Protocol] router. A possible problem with the known router is that, in some circumstances, the processor is not able the follow the incoming flow of packets from the termination link. This occurs for instance when the data traffic come into the router at the line rate. The processor may then run out of resources because there is not enough memory and/or processing power available to handle all the incoming packets.

A first solution to solve the problem of line rate data traffic is to install a “policer” to limit the traffic to the processors. Such a policer is for instance of the type GSR12416 of CISCO™ or of the type M160 of JUNIPER™, which are already known and used in the art, e.g. as mentioned at page 12 of a article published on the Internet web site:

http://www.mrv.com/downloads/PDF/CWNT/ [symbol] CharlottesWebMarketing.pdf

(wherein the symbol “ [symbol] ” merely indicates that the statement continues on the next line without space or return character between).

However, it is very difficult to configure the policer for using the resources of the processor in optimal way. For instance, if the policer is configured to handle only 10 pps [Packets Per Second] for an ICMP [Internet Control Message Protocol] “destination unreachable”, whilst the processor can handle up to 50000 pps, the processor is obviously not used well enough.

Furthermore, the policer cannot be configured properly to prevent all possible attacks. In the area of security, for instance, a lot of issues for DoS [Denial of Service] attacks cannot be resolved therewith.

An object of the present invention is to provide a telecommunication router of the above known type but wherein the processor is used in an efficient and optimal way.

According to the invention, this object is achieved due to the fact that said telecommunication router further comprises a plurality of queues adapted to store packets of data prior to be transferred to said processor, and a packet classifier adapted to receive packets of data from said termination link, to classify the received packets according to predetermined types, and to forward classified packets towards one queue out of said plurality, said one queue being selected according to the type of the forwarded packet, that each of said predetermined types is associated to a predetermined priority, and that said processor is adapted to retrieve packets of data from the queues of said plurality according to predetermined priority rules.

In this way, the packets of data are treated based on the current load of the processor. By buffering packets in the queues, the processing power is used as much as possible and a maximum of packets is processed as a function of the available processing power. The processor is thus used in an optimal way with respect to the efficiency of the telecommunication router.

Furthermore, packets of data can be retrieved and handled by the processor in function of their priority rather than in function of the order of incoming from the termination link into the telecommunication router.

In a preferred embodiment of the present invention, said processor is adapted to retrieve packets of data from a queue associated to a relative high predetermined priority prior to retrieve packets of data from another queue associated to a relatively lower predetermined priority.

As a result, the router will allow low priority traffic to be handled depending on how much load the processor has and also depending on how many higher priority tasks are scheduled.

Also another characterizing embodiment of the present invention is that each queue of said plurality of queues is controlled by a queue manager adapted to discard packets coming from said packet classifier when a predetermined threshold filling level of the queue is reached.

A generic overload protection is thereby provided.

Preferably, each queue of said plurality of queues has a different predetermined threshold filling level.

The overload protection is thus dependent of the data traffic type, i.e. according to the priority, rather than of the normal incoming traffic flow.

In variants of the present invention, a plurality of termination links are connected to said packet classifier and/or a plurality of processors are adapted to retrieve packets of data from said queues.

Further characterizing embodiments of the present telecommunication router are mentioned in the appended claims.

It is to be noticed that the term ‘comprising’, used in the claims, should not be interpreted as being restricted to the means listed thereafter. Thus, the scope of the expression ‘a device comprising means A and B’ should not be limited to devices consisting only of components A and B. It means that with respect to the present invention, the only relevant components of the device are A and B.

Similarly, it is to be noticed that the term ‘coupled’, also used in the claims, should not be interpreted as being restricted to direct connections only. Thus, the scope of the expression ‘a device A coupled to a device B’ should not be limited to devices or systems wherein an output of device A is directly connected to an input of device B. It means that there exists a path between an output of A and an input of B which may be a path including other devices or means.

The above and other objects and features of the invention will become more apparent and the invention itself will be best understood by referring to the following description of an embodiment taken in conjunction with the accompanying drawings wherein the figure (Fig.) represents a telecommunication system according to the invention.

The telecommunication router shown in the figure comprises a trunk line card TLK that preferably is an IP [Internet Protocol] termination card, and a Remote Transfer Service card RTS.

Several termination links, of which only one TL is shown, are coupled to the line card TLK. The termination link TL carries packets of data and may for instance transmit these packets according to the transmission protocols “OC48” or “OC192”, whereby the packets arrive in the line card TLK at a rate of 2.6 Gbps or 10 Gbps, corresponding to 6.1 Mpps or 25 Mpps respectively.

The line card TLK comprises a packet classifier CL to which the termination link TL is coupled. The classifier CL receives the packets from the line TL and classifies them according to their type. Particular types of packets of data are for instance indicated by the messages:

“TTL=00/1”: “Time-To-Live” [TTL] is a value in an Internet Protocol [IP] packet that tells the telecommunication router whether or not the packet has been in the network too long and should be discarded;

“Options”: corresponds for instance to packets whereof the contents indicates “Loose Source Routing” [LSR];

“No Dest”: corresponds to an “Internet Control Message Protocol” [ICMP] which is a message control and error-reporting protocol between a host and a gateway to the Internet;

signaling such as “Resource Reservation Protocol” [RSVP] that is a set of communication rules that allows channels or paths on the Internet to be reserved for the multicast (one source to many receivers) transmission of video and other high-bandwidth messages. RSVP is part of the Internet Integrated Service [IIS] model, which ensures best-effort service, real-time service, and controlled link-sharing;

Routing Protocols such as “Border Gateway Protocol” [BGP] that is a protocol for exchanging routing information between gateway host in a network of autonomous systems, or “Open Shorted Path First” [OSPF] that is a router protocol used within larger autonomous systems networks in preference to the “Routing Information Protocol” [RIP];

Internal Communication messages;

etc . . .

All these types are associated to a transmission priority through the telecommunication router. By way of example:

the highest priority, say P3, will be given to the Internal Communication messages;

a relatively lower priority, say P2, will be given to BGP and OSPF;

still a relatively lower priority, say P1, will be given to RSVP; and

the lowest priority, say P0, will be given to TTL, LSR and ICMP.

The packet classifier CL of the line card TLK has several outputs which are connected to inputs of distinct queues located on the remote transfer service card RTS. The card RTS is provided with four queues P0, P1, P2 and P3 of which respective outputs are connected to a common processor PROC also located on the card RTS. The packet classifier CL is connected to the queues P0-P3 in such a way that each queue receives packets of its like-named priority P0-P3. As a result, the packets with the highest priority are stored in the queue P3, whilst those with the lowest priority are stored in the queue P0. This classification to the different queues can obviously be configured.

In a preferred embodiment, the packet classifier CL estimates the priority P0/P3 by analyzing the content of the packet. CL then forwards the analyzed packet to the queue P0/P3 corresponding to the estimated priority.

The processor PROC first retrieves and handles the packets of the highest priority queue P3. The packets are treated based on the current load of the processor. Once the queue P3 is empty, the processor PROC starts retrieving and handling the packets of the queue P2, and so further until the lowest priority queue P0. The packets are thus handled by the processor PROC in function of their priority rather than in function of the order of incoming from the termination link TL into the line card TLK.

In order to prevent overload of the queues, each queue P0-P3 is controlled by a queue manager (not shown) that discards packets arriving from the packet classifier CL when a predetermined threshold filling level T0-T3 of the queue is reached. This threshold filling level T0-T3 may be different for each of the queues P0-P3 respectively. It is thereby possible to obtain a telecommunication router of which the data traffic is dependent of the types of packets and their associated transmission priority rather than of the incoming traffic flow.

As already mentioned, the processor PROC threats the packets based on its load and on how many packets are still in the different queues. If a certain threshold T0/T3 of a queue P0/P3 is exceeded, the processor PROC can't handle new messages any longer and any new incoming packet will be discarded.

It is to be noted that the packet classifier CL is further provided with an additional output OUT towards which packets that are not intended to the processor PROC will be forwarded.

It is also to be noted that, in a variant of the present telecommunication router, the Remote Transfer Service card RTS may be provided with several processors, similar to the processor PROC. Each of the processors is then able to retrieve packets of data from the queues P0-P3. This allows increasing the efficiency and the handling speed of the system.

A final remark is that embodiments of the present invention are described above in terms of functional blocks. From the functional description of these blocks, given above, it will be apparent for a person skilled in the art of designing electronic devices how embodiments of these blocks can be manufactured with well-known electronic components. A detailed architecture of the contents of the functional blocks hence is not given.

While the principles of the invention have been described above in connection with specific apparatus, it is to be clearly understood that this description is made only by way of example and not as a limitation on the scope of the invention, as defined in the appended claims.

1. A telecommunication router (TLK, RTS) connected to a termination link (TL) and comprising a processor (PROC) adapted to handle packets of data received from said link,
characterized in that said telecommunication router further comprises a plurality of queues (P0-P3) adapted to store packets of data prior to be transferred to said processor (PROC), and a packet classifier (CL) adapted to receive packets of data from said termination link, to classify the received packets according to predetermined types, and to forward classified packets towards one queue out of said plurality, said one queue being selected according to the type of the forwarded packet,
in that each of said predetermined types is associated to a predetermined priority,
and in that said processor is adapted to retrieve packets of data from the queues of said plurality according to predetermined priority rules.

2. The telecommunication router according to claim 1, characterized in said processor (PROC) is adapted to retrieve packets of data from a queue associated to a relative high predetermined priority prior to retrieve packets of data from another queue associated to a relatively lower predetermined priority.

3. The telecommunication router according to claim 1, characterized in that said packet classifier (CL) is adapted to estimate said predetermined priority by analyzing the content of a packet and to forward the analyzed packet to the queue corresponding to the estimated priority.

4. The telecommunication router according to claim 1, characterized in that each queue of said plurality of queues (P0-P3) is controlled by a queue manager adapted to discard packets coming from said packet classifier (CL) when a predetermined threshold filling level (T0-T3) of the queue is reached.

5. The telecommunication router according to claim 4, characterized in that each queue of said plurality of queues (P0-P3) may have a different predetermined threshold filling level (T0-T3).

6. The telecommunication router according to claim 1, characterized in that said processor (PROC) is adapted to retrieve packets of data from said queues according to the load of said processor.

7. The telecommunication router according to claim 1, characterized in that a plurality of termination links (TL) are connected to said packet classifier (CL).

8. The telecommunication router according to claim 1, characterized in that a plurality of processors (PROC) are adapted to retrieve packets of data from said queues.

9. The telecommunication router according to claim 1, characterized in that said packet classifier (CL) is adapted to forward to an output port (OUT) of said telecommunication router (TLK, RTS) packets that are not intended to said processor (PROC).
